(19) United States
(12) Patent Application Publication
(10) Pub. No.: US 2008/0168503 A1
(43) Pub. Date: Jul. 10, 2008

(54) System and Method for Selecting and Viewing Broadcast Content Based on Syndication Streams

(75) Inventor: Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/620,944

(22) Filed: Jan. 8, 2007

(51) Int. Cl. G06F 3/01

(52) U.S. Cl. 725/58

(57) ABSTRACT

A system and a method for alerting a Digital Video Recorder (DVR) viewer as to content that meets a predefined criteria of the viewer embedded within a real-time internet web feed and allowing the viewer to elect to view and/or record detected content that meets such criteria while viewing other content.

### FIELD OF THE INVENTION

The present invention relates generally to digital video recorders and more specifically to a system and method for providing a person viewing a current program, live or recorded on a digital video recorder, with an alert providing information as to relevant new broadcast content and for allowing the viewer to select the new broadcast content for playback or recording.

### BACKGROUND OF THE INVENTION

Digital Video Recorders (DVRs) (or Personal Video Recorders (PVRs) have revolutionized the television recording industry. DVRs may be implemented as stand alone devices that are interconnected to other devices. Alternatively, DVRs may be implemented or as a subsystem of a set-top terminal, media center or television, and can control the channel tuned on the television, provide an interactive electronic program guide, and record programming on a manual or timed controlled basis. DVRs allow a viewer to record a broadcast being transmitted by a broadcast source and store the material on a storage device such as a Hard Disk Drive (HDD), a Compact Disk (CD) or a Digital Versatile Disk (DVD). The broadcast may be encoded and/or compressed before being stored on the storage device. The recorded broadcast may be displayed on a television (TV) set or other display device. The term display device, as used herein, refers to known display associated with a TV or computer system, including desktop and laptop systems.

There are various systems for recording a broadcast from a broadcasting source, using a recording device. In one such system, a server stores the broadcast when a viewer sends an instruction to the server through the Internet, using a computer. In another system, a viewer may access and query an Electronic Program Guide (EPG) through a network (such as a Local Area Network, Internet or a phone line) or a remote control, to obtain details and record the broadcast on a Digital Video Recorder (DVR). Once the broadcast is selected for recording, the viewer may control the recording by using the EPG and the DVR. In yet another system, a viewer may log on to a program server, to select the broadcast to be recorded on a recording device. The program server has a program selection tool that helps the viewer to select the program to be recorded. Once a program is selected, the program server begins controlling the recording device to monitor the recording.

Existing DVR systems allow the viewer to record shows based on: a) viewer selection through an Electronic Program Guide (EPG), b) viewer selection through templates (e.g. “record all Simpsons episodes” or anything relating to the “America's Cup”), c) predictive engines (watch what the viewer records and record similar programs), or d) record based on time and date.

However, Digital Video Recorders (DVRs) do not provide a suitable means for information and entertainment “snacking”. More specifically, the above-mentioned systems do not provide a mechanism to allow a viewer to view an initial broadcast program while simultaneously monitoring information as to the viewer's desired information, alert the viewer as to new content corresponding to the viewer's desired information, either as it happens or shortly thereafter, and allow the viewer to spontaneously select the new content for immediate playback or recording, and spontaneously playback or record the initial broadcast program being displayed.

### BRIEF DESCRIPTION OF THE DRAWINGS

The present invention is illustrated by way of example, and not limitation, in the accompanying figures, in which like references indicate similar elements, and in which:

FIG. 1 is block diagram illustrating an exemplary DVR system for communicating an alert regarding soon-to-be or recently broadcast content and providing a means to watch or record the content, in accordance with an embodiment of the present invention

FIG. 2 is a more detailed block diagram providing further exemplary details of the main components of the DVR system of FIG. 1.

FIG. 3 is a block diagram illustrating software layers that may be included within the system illustrated in FIG. 1.

FIG. 4 is one example of what a viewer would see on a screen of a television in the system illustrated in FIG. 1.

FIG. 5 illustrates an example of what a viewer would see on the screen if he selects a request for additional information.

FIG. 6 illustrates a further example of what a viewer would see on the screen when the system has been configured to alert the viewer to local news events.

FIG. 7 illustrates an example of what a viewer would see on the screen if he selects a request for additional information.

FIG. 8 illustrates an interactive screen presented to a viewer that includes a scrollable list of recorded clips and allows for playback of the recorded clips.

FIG. 9 is a flowchart illustrating one process by which the DVR system monitors broadcast content based upon syndication streams.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

Broadcast and multicast of content are frequently the most efficient means for distributing content, while Video On Demand (VOD) frequently provides the most convenience to a viewer in terms of being able to watch content when and where the viewer wants. Digital Video Recorder (DVR) systems create a more “on demand” experience by allowing a viewer to “time shift” television shows—setting content to record with the ability to watch it moments, days or even months later. But the World Wide Web has created the phenomenon of information and entertainment “snacking”. Instead of “consuming” an entire album, newspaper or baseball game, for example, a viewer is more likely to grab content (or “bite size clips”) from many sources either simultaneously or in rapid succession. A viewer might use an RSS reader on their computer desktop, for example, to monitor top emerging news stories while watching the box score of the game in a web browser.

Digital video recorder systems in the prior art do not provide this level of granularity or the ability to quickly locate content as it happens. The present system provides a means to communicate alerts about soon-to-be or recently broadcast events and a means for the viewer to either watch or record the referred-to content.

One embodiment uses RSS XML information to present an interactive application with changes, updates and alerts. The application will monitor various aggregated RSS streams and present the viewer with alerts based on the viewer's interests either explicitly selected by the viewer or implicitly (related to channels) or based on predictive engines monitoring a viewer's actions to predict what other similar items they may like.

RSS is a family of standard internet web feed formats used to deliver content through data feeds over the network to a viewer based upon a set of request parameters outlined by the viewer. Unlike email or IM in which content is “pushed” to the subscriber, in RSS, the content is “pulled” to the subscriber in that the aggregator checks for new content at viewer-determined intervals and retrieves the update. RSS TV is an extensible markup language (XML)-based navigation protocol for Internet Protocol Television (IPTV) services based on the RSS standard. For example, by listing a web page as an “item” in an RSS file, that page may appear in front of those who read RSS information using RSS readers. These programs, known as feed readers or aggregators, are used to check a list of feeds on behalf of a viewer and display any updated information that is found. RSS feeds use tags in brackets < > to define its contents—including title (the name of the channel similar to the title of a website or web page), link (the URL to the HTML website) and description (the phrase or sentence describing the content of the entire feed). Various other tags within an RSS feed are optional including category, author, duration, etc. Using a syndication stream allows a viewer to jump to specific locations in a video stream that may be viewed and/or recorded concurrently with currently viewed first program.

For example, if a person is viewing a program broadcast over a broadband connection on a display device (say the San Francisco Giants vs. the LA Dodgers baseball game) but would like to be aware of all updated news that is reported concerning another baseball game, the Boston Red Sox vs. the Kansas City Royals (while still viewing the Giants/Dodgers game). The system/method allows a viewer to maintain the broadband connection of the first program, and receive relevant updated information through a syndication stream. The updates may be presented to the viewer in accordance with predetermined options selected by the viewer—including presentation of the syndication updates in only a portion of the viewing screen or the entire screen.

As described below in more detail, a DVR system described herein is connected to the Internet, or to a personal computer that is connected to the Internet. Updated information desired by the viewer, such as current news event updates or sports updates for example, is extracted from web-sites and delivered directly to the using the RSS (or other XML or text-based) protocol. An interactive application within the DVR system provides the viewer with ability to monitor events of interest in future or currently buffered broadcast streams, find out more information, and view or record the streams based on the information. The RSS stream may include text or video clips as well as key information such as a program's title, start time, duration, etc.

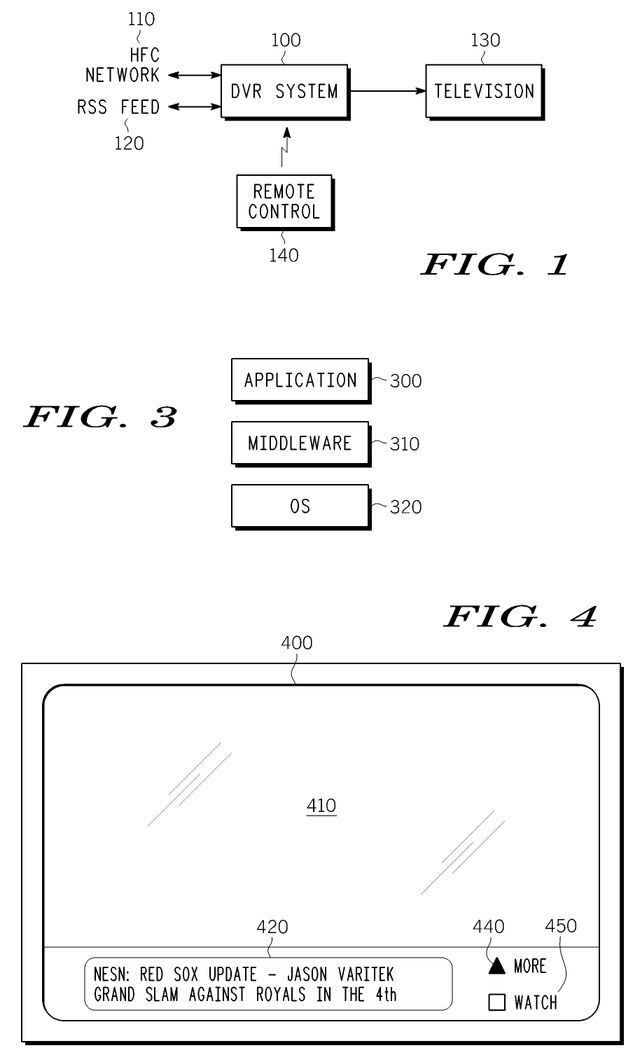

An exemplary system is depicted in FIG. 1. As shown, a DVR system 100 receives cable television signals 110 over an HFC network (for example, these signals could be satellite, over-the-air, fiber to the premise, xDSL, etc.). The DVR system 100 also receives a real-time or pseudo real-time content stream, such as an XML-based RSS feed 120. An information update module (for example, in the case of an RSS feed, an “aggregator”) (both discussed in greater detail below) can check the RSS feed for any changes in content and react to the changes in an appropriate way (e.g., by displaying new items).

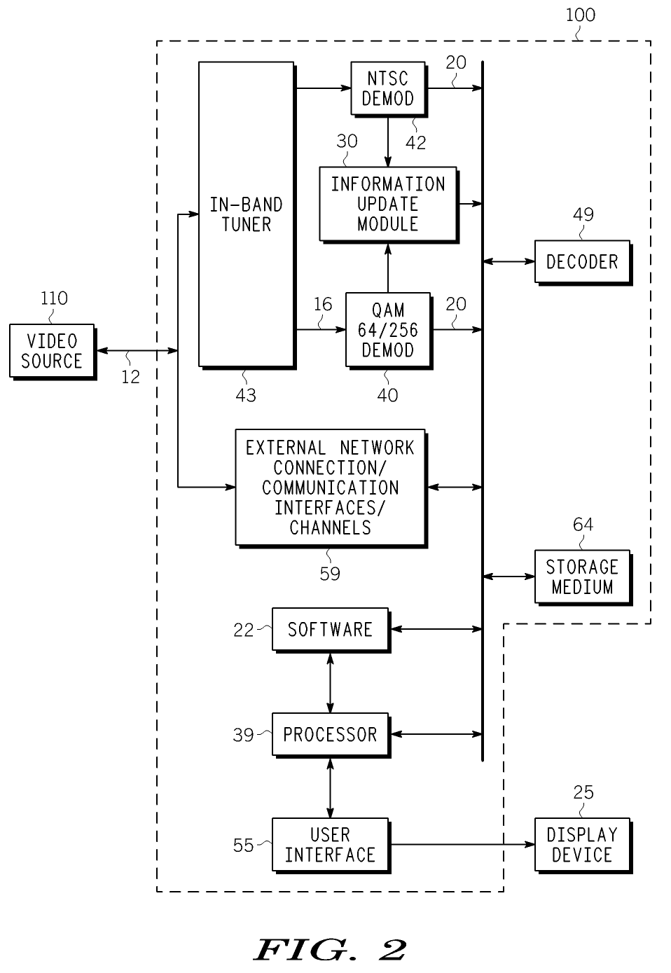

FIG. 2 provides a more detailed block diagram of one example of a DVR system 100 (hereinafter “system 100”) of FIG. 1. System 100 receives video signals 12 from video source 1 10. In one particular example, DVR system 100 is a DVR-enabled cable set-top box, video source 110 is a hybrid fiber-optic/coax cable network operated by a cable television operator, and video signal 12 is a multi-channel analog and/or digital programming source broadcast by the cable operator.

DVR System 100, however, may be any device or combination of devices capable of receiving, recording and playing back video signal 12; broadband network/video source 110 may be any public or private, wired or wireless, video transmission infrastructure or technology, including but not limited to a fiber-optic network, a coaxial cable network, a hybrid network, a satellite network, cellular network, the Internet, a television network, a radio network, a copper wire network, or any other existing or future transmission infrastructure or technology, operated by any type of program provider, such as a television network or station, a studio, an Internet broadcaster or service provider, a cable operator, or a satellite operator; and video signal 12 may be any pre-recorded or live analog or digital electronic signal representing an image and/or audio, in any format.

DVR system 100 includes external network connection/communication interfaces 59, which support devices such as modems, streaming media players and other network connection support devices and/or software, coupled through local or wide area networks (not shown) to program providers and providers of other content, such as advertising content. DVR system 100 further includes an in-band tuner 43, which tunes to a channel signal 16 selected by a viewer via user interface 55. User interface 55 may be any type of known or future device or technology allowing the consumer to select channels or programs the consumer wishes to receive, such as a remote control, mouse, microphone, keyboard, or touch-screen display associated with a personal video recorder.

Channel signal 16 includes video and/or audio components. Demodulators 40 and 42 are responsive to in-band tuner 43. Demodulator 40, which may be a 64/256 quadrature amplitude modulation demodulator, for example, is responsive to receive a digital version of channel signal 16. Demodulator 40 identifies digital data packets from one or more digital sources, such as a Moving Pictures Experts' Group (MPEG) transport stream, a high-definition television stream, or a media stream from an external network connection 59, such as a cable modem, using well-known methods and techniques. Demodulator 42, which may be an NTSC demodulator, for example, is responsive to receive an analog version of channel signal 16 and to decode signals and markers according to well-known methods and techniques. Demodulators 40 and 42 are operative to output video information 20.

Video information 20 includes raw video or audio data, arranged for formatting in accordance with a predetermined media format. Video information 20 is preferably arranged in accordance with an MPEG media format, such as the MPEG-2 media format, but may be arranged in accordance with other media formats, including but not limited to other MPEG formats, Hypertext Markup Language (HTML), Virtual Hypertext Markup Language (VHTML), X markup language (XML), H.261, or H.263 formats.

Storage medium 64 is responsive to receive, among other things, encoded video signal 20 for storage. Storage medium 64 may be any local or remote device, now known or later developed, capable of recording data, including but not limited to a hard disk drive, a videocassette recorder tape, all types of optical storage media such as compact disks and digital videodisks, a magnetic tape, a home router, or a server.

Decoder 49 is responsive to receive recorded encoded video signal 20 from storage medium 64, and to play back recorded encoded video signal 20 via display device 25, in response to instructions from user interface 55. Decoder 49 is also responsive to receive and pass through video programming directly from tuner 43. Internal arrangements of decoder 49 are well known--decoder 49 may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Display device 25, which also includes speakers for outputting audio signals, displays video programming received from tuner 43 or storage medium 64. Display device 25 is responsive to receive analog or digital signals, including but not limited to S-video, composite audio-video, SPDIF, and DVI.

Processor 39 and software 22 are illustrated functionally, and are responsive to various elements of DVR system 100, including demodulators 40 and 42, storage medium 64 and decoder 49. When loaded into a processor, such as processor 39, software 22 is operative to control encoding, decoding, recording and playback of encoded video signal 20. It will be appreciated, however, that aspects of the DVR system are not limited to any specific embodiments of computer software or signal processing methods. For example, one or more processors packaged together or with other elements of DVR system 100 may implement functions of processor 39 in a variety of ways. It will also be appreciated that software 22 may be any stored instructions, in one or more parts (stored, for example, on storage medium 64, or another internal or external storage medium such as a read-only-memory or a random-access memory) electronically controlling functions provided by DVR system 100, including firmware, and may be used or implemented by one or more elements, including one or more processors, of DVR system 100.

During normal operation of the DVR system 100, a viewer using user interface 55 selects a particular program to be recorded from video source 110 and/or selects a recorded program for playback from storage medium 64. When a program is to be recorded, an encoded video signal 20 associated with the selected program is transferred to storage medium 64. Likewise, when a program is to be played back, an encoded video signal 20 associated with the selected program is transferred from storage medium 64 to decoder 49 for processing. Decoder 49 demultiplexes and decodes encoded video signal 20 for presentation to the consumer via display device 25.

A viewer might be interested in monitoring news, corporate information, sports or other information, while continuing to watch the primary content currently being viewed. To address this desire, DVR system 100 monitors a second data stream, e.g., an RSS feed or stream, in accordance with criteria input by the viewer or based upon the viewer's history to detect the desired information.

In order to monitor the input RSS feed, the DVR system 100 includes an information update module 30 (more specifically, with any type of client software that uses a web feed to retrieve syndicated web content, the information update module is referred to as an aggregator or feed reader) (see FIG. 2) to analyze, detect and extract the information relevant to the viewer (again, as either input by the viewer to the DVR system, or as predicted by the DVR system based on previous viewer actions). As with the other functional elements shown in FIG. 2, the information update module 30 may be embodied in software, hardware, or any combination thereof and can implement any of a variety of different techniques for performing a predictive process to determine programs/information of interest which are known to those of ordinary skill in the art.

While data feeds commonly include written text, it should be noted that data feeds may include audio, moving pictures, still pictures, executable files, application-specific files and the like.

The DVR system 100 is connected to a television 130, delivering live, time-shifted, or pre-recorded content. An optional remote control 140 is also shown in FIG. 1. The DVR system 100 is also capable of running applications and displaying a Graphical User Interface superimposed or alpha blended with the video content. At the architecture level, this system may include software layers (broadly illustrated in FIG. 3) such as application 300, middleware (e.g. MHP, OCAP, NDS XTV, OpenTV, etc.) 310 and an operating system (OS) or Hardware Abstraction Layer (HAL) 320.

In one embodiment, a viewer is given the option of initiating an interactive application that, in this embodiment, is displayed simultaneously with whatever other content or applications the viewer is watching. This interactive application may reside in any one of the layers shown in FIG. 3. The interactive application receives a secondary content feed, such as an XML RSS feed, that provides information used by the interactive application to provide alerts or other informational notifications to the viewer. The secondary content feed may link to alerts as to upcoming content, e.g. “News Alert: continued rains lead to flooding in western Massachusetts.” Alerts may be based on selected feeds based on user models, user preferences or user actions (described in more detail below).

In a first exemplary scenario, a viewer is watching one baseball game, the San Francisco Giants vs. the LA Dodgers, while interested in the progress of another, the Boston Red Sox vs. the Kansas City Royals. In order to watch the first game and “keep tabs” on the second game, the viewer launches the interactive application. The interactive application may monitor a content feed specific to the second game, or, may rely upon a general aggregator application accepting feeds from the second game and many other sources as well. As part of following the alert stream from the second game, the viewer may be given the option of recording the game in the background, if there are free “tuners” (while FIG. 2 is illustrative of a DVR system having only one tuner, of course DVR systems with two or more tuners may be implemented as well—for example, dual-tuner DVRs include two tuners within the same receiver to operate independently of one another, providing the capability to record a live program while watching another live program simultaneously or to record two programs at the same time while watching a previously recorded program) or Internet Protocol Television (IPTV—in which digital television service is delivered using the Internet Protocol over a network infrastructure) bandwidth in the background, or if the game is provided on the same modulated multiplex as the first game.

FIG. 4 illustrates one example of what the viewer might see on the television screen 400. The live stream of the first game is presented in a portion of the screen 410. The interactive application user interface is provided in the remainder of the screen—either persistently, or only when an alert is presented. In the latter case, the first game would be shown in the entire screen when no alert is present.

When some update to the second game is available, an alert 420 is presented to the viewer. The viewer is given the option of finding out more information about the alert by pushing a remote control button (suggested in the GUI by menu item 440), or the viewer is given the option of switching to view the segment of the second game related to the alert by pressing a different remote control button (suggested in the GUI by menu item 450). In one case the first game may be paused when the viewer switches to watch the second game, allow the viewer to return exactly where they left off.

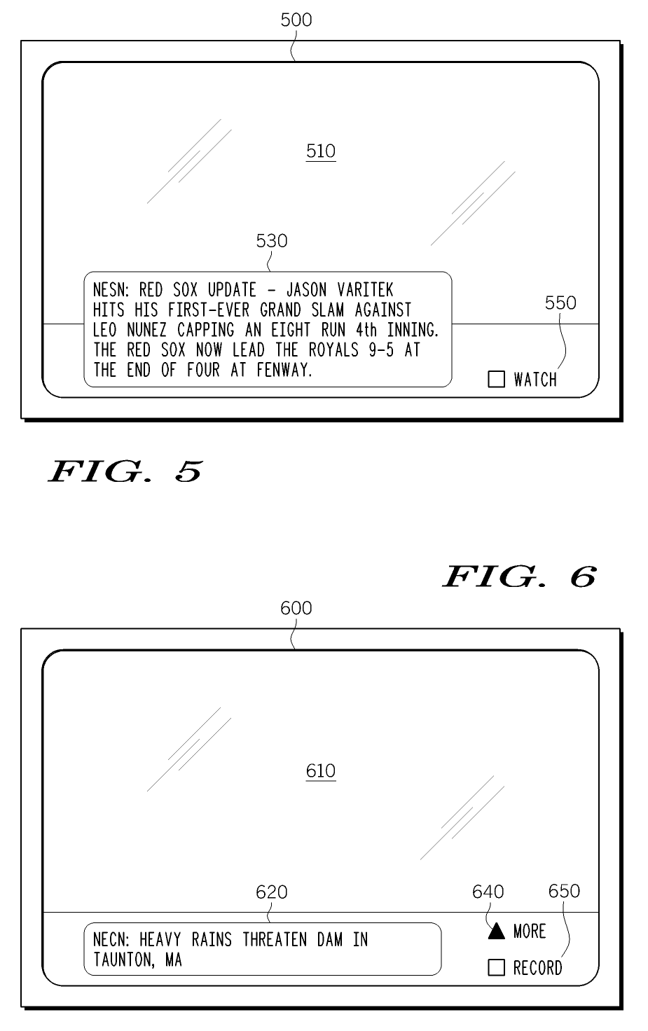

FIG. 5 illustrates additional information that may be provided by the interactive application if the viewer requests additional details. Depending on the amount of detail, the alert 530 may encroach further on the stream being watched 510. Again the viewer is given the opportunity to watch the associated video 550.

In this example, if the viewer chooses to watch the related video, the presented video 510 will switch to the Red Sox game at a point shortly before the event described by the alert 530. The alert stream may then show events related to the first game in progress, providing the viewer with queues as to what they are missing on the other stream.

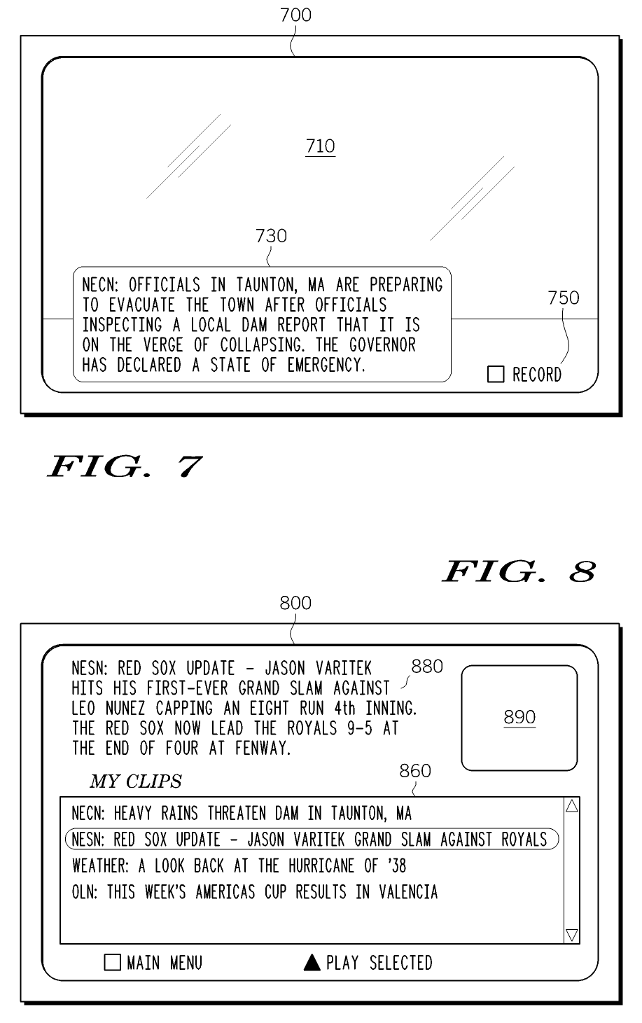

In a second scenario illustrated in FIG. 6, a viewer is watching a movie in the main screen 600. The aggregator application has been configured to alert the viewer to local news events. Some of these aggregated events are associated with broadcast content sources (e.g. CNN or NECN). In this example, an alert event is detected for a local news story that is developing 620. The alert is also associated with a news story that will be broadcast on a local cable news station NECN. The viewer is given the option of finding out more about the story 640 or requesting that the DVR record the news segment when it airs 650. As with scenario 1, selecting more information 640 displays additional details on the screen [see 730 FIG. 7].

FIG. 8 depicts an example of how a viewer might review a list of recorded clips based on alert recording. A viewer presented with screen 800 might scroll through a list of clips 860, and have the ability to view the recorded additional information from the alert (here shown as 880 in the upper left corner). A picture in graphics 890 might be present in the upper right corner. A viewer might be able to select many clips for playback, or playback all.

The interactive application will map the viewer preferences to RSS sources and monitor those sources for changes in information, for example highlights in a game log. An added component in the RSS feed associated with a video source would be tags, such as time markers, indicating to the DVR system what broadcast content is related to the alert, what channel, what time codes, etc.

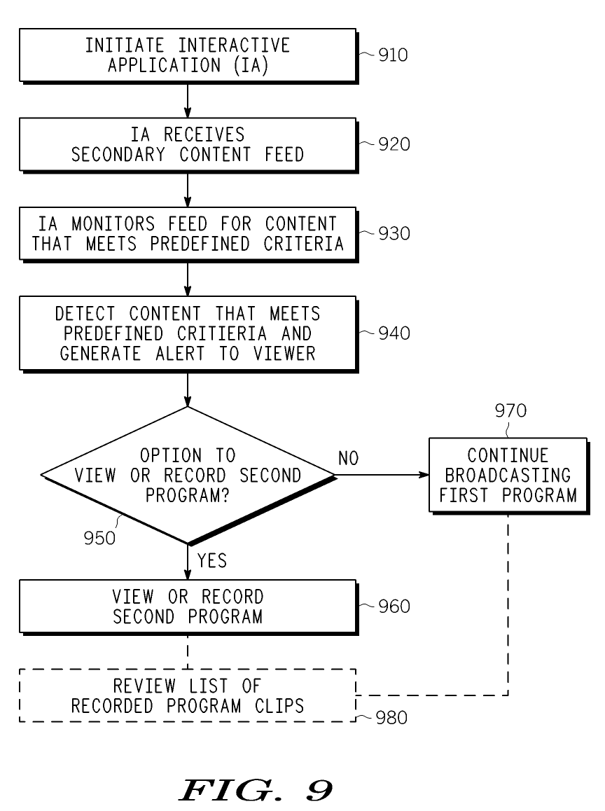

FIG. 9 is a flowchart illustrating one process by which the DVR system provides information as to broadcast content based on syndication streams to a DVR viewer. First, in step 910 the viewer initiates the interactive application (IA) and selects first content for viewing using the user interface. In response, in step 920, the interactive application receives a secondary content feed (e.g., an XML RSS feed). The interactive application monitors the secondary content feed for information contained therein that meets some criteria as to the viewer's desired information (i.e., based upon either input expressly provided by the viewer through the user interface as to desired information alerts (or “content of interest” to the viewer), or based upon previous viewer interactions) (step 930). The secondary content feed allows the viewer to locate and record specific segments within the feed using tags referencing those segments of content embedded within the secondary content feed. Upon detection of information that meets the criteria as to the viewer's desired information, the interactive application displays an alert to the DVR viewer simultaneously with the first content (step 940). The alert provides the viewer with a summary of detected information. The alert may include a Graphical User Interface, superimposed with the currently-viewed first content, and can give the viewer various additional options including the opportunity to request “more information” (i.e., a more detailed alert), “record the detected second content” or “immediately watch a program associated with the detected second content”. If the secondary content feed provides only a summary of currently-broadcast program material, but not a feed to the actual program itself, upon a selection by the viewer to “record” or “watch” the second program, the interactive application may query an Electronic Program Guide (EPG) and use the information provided in the secondary content feed to locate the second program and to tune to that program (RSS TV-compliant EPGs can be implemented using any language and operating system including dynamic hypertext markup language (DHTML), Flash, OpenTV, or C). Continuing to step 950, if the viewer selects the option to “immediately view or record the detected second program”, the viewer is presented with the second program (step 960), while being provided with an option in which the interactive application then monitors the first content for information alerts regarding that content. If based upon the alert provided, the viewer does not wish to view or record the detected second program, broadcasting of the first content continues (step 970). Finally, at any time, a viewer may, through the user interface, activate a memory within the DVR system to review a list of recorded program clips, including the alert information and the more detailed alert information, and may select one or more desired program clips for playback (step 980).

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

The process shown in FIG. 9 may be implemented in a general, multi-purpose or single purpose processor. Such a processor will execute instructions, either at the assembly, compiled or machine-level, to perform that process. Those instructions can be written by one of ordinary skill in the art following the description of FIG. 9 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

This invention provides a means for a viewer to monitor real-time events associated with broadcast content through the use of updated syndication information (e.g. RSS XML streams). An interactive application provides the viewer with ability to monitor events of interest in future, or currently buffered broadcast streams, find out more information, and view or record the streams based on the information.

In various embodiments of the present invention, the broadcast may be a video broadcast, an audio broadcast, an image broadcast, a data broadcast, or a combination of the above broadcasts.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for providing an alert indicating the detection of content of interest in a Digital Video Recorder (DVR) system, and presenting a viewer with the option to view and/or record the other content of interest while viewing first content, the method comprising the steps of:
receiving an internet web feed at an input to the DVR system, the web feed containing updated syndication information;
monitoring the internet web feed for broadcast content of interest;
providing an alert to the viewer if broadcast content of interest is detected in the monitoring step, the alert provided to the viewer concurrently with the first content.

2. The method of claim 1, wherein the alert includes a user interface that allows the viewer to instruct the interactive application to display the broadcast content of interest while continuing to broadcast the first content.

3. The method of claim 1, wherein the alert includes a user interface that allows the viewer to instruct the interactive application to record the broadcast content of interest while continuing to broadcast the first content.

4. The method of claim 1, wherein the interactive application determines content of interest to the viewer by receiving user selection data through an Electronic Program Guide (EPG).

5. The method of claim 1, wherein the interactive application determines content of interest to the viewer by viewer selection through templates.

6. The method of claim 1, wherein the interactive application determines content of interest to the viewer by predictive engines.

7. The method of claim 1, wherein the interactive application determines content of interest to the viewer by viewer selection based on time and date.

8. The method of claim 1, further comprising providing the viewer with a summary of the detected content of interest.

9. The method of claim 8, further comprising providing the viewer with the option to request additional information as to the detected content of interest.

10. The method of claim 1, wherein the alert is displayed simultaneously with the other content.

11. The method of claim 1, wherein the other content is provided by a cable television signal and wherein the alert is displayed on the periphery of a television screen of the DVR system.

12. The method of claim 1, wherein the internet web feed comprises an RSS feed and wherein the RSS feed includes tags referencing segments of content embedded within the RSS feed.

13. The method of claim 12, wherein the interactive application uses the tags to jump to content of interest.

14. A digital video recorder (DVR) system for alerting a viewer as to content of interest embedded within a real-time internet web feed and allowing the viewer to view other content, the system comprising:
an input for receiving first broadcast content;
an input for receiving a real-time internet web feed, the web feed containing information; and
an information update processor module responsive to an interactive application software program therein, wherein the processor module:
monitors the real-time internet web feed for broadcast content determined by the interactive application to match a predefined criteria of the viewer; and
provides an alert to the viewer if broadcast content that meets the predefined criteria is detected in the monitoring step.

15. The system of claim 14, wherein the real-time internet web feed comprises XML-based Really Simple Syndication (RSS).

16. The system of claim 14, wherein the predefined criteria is input as viewer preferences by the viewer to the interactive application.

17. The system of claim 14, wherein the predefined criteria is determined by the interactive application based upon previous viewer actions.

18. The system of claim 14 further comprising a remote control device, wherein said remote control device interacts with said interactive application to control viewing and/or of the broadcast content that meets the predefined criteria.

19. The system of claim 14, the alert further comprising a user interface that allows the viewer to instruct the interactive application to display the broadcast content that meets the predefined criteria while viewing other content.

20. The system of claim 14, the alert further comprising a user interface that allows the viewer to instruct the interactive application to record the broadcast content that meets the predefined criteria while viewing other content.
